(19) United States
(12) Patent Application Publication
(10) Pub. No.: US 2004/0120344 A1
(43) Pub. Date: Jun. 24, 2004

(54) Device discovery application interface

(75) Inventors: Naoyuki Sato, Campbell, CA (US); Kevin K. Lym, San Jose, CA (US); Jadie Sun, Millbrae, CA (US)

Correspondence Address: HAVERSTOCK & OWENS LLP, 162 NORTH WOLFE ROAD, SUNNYVALE, CA, 94086, US

(73) Assignee: Sony Corporation and Sony Electronics, Inc.

(21) Appl. No.: 10/327,574

(22) Filed: Dec. 20, 2002

(51) Int. Cl. H04J 3/16

(52) U.S. Cl. 370/465

(57) ABSTRACT

A device discovery application programming interface (API) provides an interface to discover the presence of network devices. The device discovery API preferably resides within a control device, where the control device can also be a network device. Each network device preferably uses IP-based protocols for sending and receiving communications related to the discovery process. The device discovery API provides an interface for an application to receive a list of network devices discovered on a network. Preferably, the discovered network devices are SSDP-enabled devices. The device discovery API enables the control point to search for a particular network device on the network and to search for particular information associated with the network device. The device discovery API also provides a framework for defining and implementing a device discovery protocol. The device discovery protocol is preferably IP-based. The device discovery API is extensible, such that the framework for defining and implementing the device discovery protocol can also provide common functionality across multiple protocols.

### FIELD OF THE INVENTION

The present invention relates to the field of transmitting information between devices. More particularly, the present invention relates to the field of providing an interface to applications involved in the transmission between devices over a bus or network.

### BACKGROUND OF THE INVENTION

The Universal Plug and Play (UPnP) standard is designed to enable simple and robust connectivity among stand-alone devices and personal computers (PCs) from many different vendors. With UPnP, a device can dynamically join a network, obtain an Internet Protocol (IP) address, convey its capabilities, and learn about the presence and capabilities of other devices. Devices can subsequently communicate with each other directly, thereby enabling discovery and control of devices. UPnP uses standard Transmission Control Protocol/Internet Protocol (TCP/IP) and Internet protocols which facilitates interoperability with existing networks.

The basic building blocks of a UPnP network are devices, services and control points. A UPnP device is a container of services and nested devices. Different categories of UPnP devices are associated with different sets of services and embedded devices. For instance, services within a VCR are different than those within a printer. The set of services provided by a particular device, as well as a list of properties associated with the particular device, are referred to in a device description document that the device must host. Preferably this device description document is written in Extensible Markup Language (XML).

A service exposes actions and models its state with state variables. For instance, a clock service can be modeled as having a state variable, current_time, which defines the state of the clock, and two actions, set_time and get_time, which enables control of the service. Similar to the device description, this information is part of a service description document preferably written in XML. The UPnP Forum defines UPnP Device and Service Descriptions according to a common device architecture. A pointer, such as a Uniform Resource Locator (URL), to each appropriate service description document is included within a device description document. Devices may include multiple services.

A service in a UPnP device includes a state table, a control server and an event server. The state table models the state of the service through state variables and updates them when the state changes. The control server receives action requests, such as set_time, executes the action requests, updates the state table and returns responses. The event server publishes events to interested subscribers anytime the state of the service changes. For instance, a fire alarm service sends an event to interested subscribers when its state changes to “ringing.”

A control point in a UPnP network is a controller capable of discovering and controlling other devices. After discovery of a network device, a control point can retrieve the device description and get a list of associated services, retrieve service descriptions for available services and invoke actions to control the service. The control point can also subscribe to the service's event source such that anytime the state of the service changes, the event server sends an event to the control point.

UPnP uses open, standard protocols such as TCP/IP, HyperText Transport Protocol (HTTP) and XML. Using these standardized protocols aids in ensuring interoperability between vendor implementations. Other technologies can also be used to network devices together. Such technologies include networking technologies such as Home Audio Video Interoperability (HAVi), Consumer Electronic Bus (CEBus), LonWorks, European Installation Bus (EIB), or X10. These too can participate in the UPnP network through a UPnP bridge or proxy.

A conventional protocol stack used to implement UPnP is illustrated in FIG. 1. The protocol stack includes a TCP/IP networking protocol stack 10, an HTTP layer 18, an HTTPU (HTTP unicast over User Datagram Protocol (UDP)) layer 20, an HTTPMU (HTTP multicast over UDP) layer 22, an SSDP (Simple Service Discovery Protocol) layer 24, a GENA (General Event Notification Architecture) layer 26, a SOAP (Simple Object Access Protocol) layer 28, a UPnP Device Architecture Defined layer 30, a UPnP Forum Working Committee Defined layer 32 and a UPnP Vendor Defined layer 34. The TCP/IP protocol stack 10 includes an IP layer 16, a TCP layer 14 and a UDP layer 12. The TCP/IP networking protocol stack 10 serves as the base on which the rest of the UPnP protocols are built. By using the standard, prevalent TCP/IP protocol suite, UPnP leverages the protocol's ability to span different physical media and ensures multiple vendor interoperability. UPnP devices can use many of the protocols in the TCP/IP protocol suite including TCP, UDP, IGMP (Internet Group Multicast Protocol), ARP (Address Resolution Protocol) and IP as well as TCP/IP services such as DHCP (Dynamic Host Configuration Protocol) and DNS (Domain Name System). TCP/IP provides the base protocol stack for network connectivity between UPnP devices.

All aspects of UPnP build on top of HTTP or its variants. HTTPU and HTTPMU are variants of HTTP defined to deliver messages on top of UDP/IP instead of TCP/IP. HTTPU and HTTPMU are protocols used by SSDP, which is described below. The basic message format used by HTTPU and HTTPMU adheres with that of HTTP and is required both for multicast communication and when message delivery does not require the overhead associated with reliability.

SSDP allows how network devices can be discovered on the network. SSDP is built on HTTPU and HTTPMU and defines methods both for a control point to locate resources on the network, and for devices to announce their availability on the network. By defining the use of both search requests and presence announcements, SSDP eliminates the overhead that would be necessary if only one of these mechanisms is used. As a result, every control point on the network has complete information on network state while keeping network traffic low.

Both control points and devices use SSDP. A UPnP control point, upon booting up, can send a multicast SSDP search request over HTTPMU to discover devices that are available on the network. The control point can refine the search to find only devices of a particular type, such as a VCR, particular services, such as devices with clock services, or even a particular device. UPnP devices listen to the multicast port. Upon receiving a search request, the device examines the search criteria to determine if they match. If a match is found, a unicast SSDP over HTTPU response is sent to the control point. Similarly, a device, upon being connected to the network, sends out multiple SSDP presence announcements advertising itself.

Both presence announcements and unicast device response messages include a pointer to the location of the device description document, which has information on the set of properties and services supported by the device.

The GENA layer provides the ability to send and receive event notifications using HTTP over TCP/IP and multicast UDP. The GENA layer also defines the concepts of subscribers and publishers of notifications to enable events. GENA formats are used in UPnP to create the presence announcements sent using SSDP and to provide the ability to signal changes in service state for UPnP eventing. A control point interested in receiving event notifications can subscribe to an event source by sending a request that includes the service of interest, a location to send the events to and a subscription time for the event notification. The subscription must be renewed periodically to continue to receive notifications, and the subscription can also be cancelled, using the GENA layer.

SOAP defines the use of XML and HTTP to execute remote procedure calls. By making use of the Internet's existing infrastructure, SOAP works effectively with firewalls and proxies. SOAP can also make use of SSL (Secure Socket Layer) for security and use of HTTP's connection management facilities. Much like remote procedure calls, UPnP uses SOAP to deliver control messages to devices and return results or errors back to control points. Each UPnP control request is a SOAP message that includes the action to invoke along with a set of parameters. The response is a SOAP message as well and includes the status, return value and any return parameters.

XML is a format for structured data on the web. XML is used to format device and service descriptions, control messages and eventing.

UPnP Vendor, UPnP Forum Working Committee and the UPnP Device Architecture define the highest layer protocols used to implement UPnP. The UPnP Device Architecture defines a schema or template for creating device and service descriptions for any device or service type. Individual working committees subsequently standardize on various device and service types and create a template for each individual device or service type. Finally, a vendor fills in this template with information specific to the device or service, such as the device name, model number, manufacturer name and URL to the device and service descriptions. This data is then encapsulated in the UPnP-specific protocols defined in the UPnP Device Architecture document, such as an XML device description template. The required UPnP specific information is inserted into all messages before they are formatted using SSDP, GENA, and SOAP and delivered via HTTP, HTTPU, or HTTPMU.

The process involved in UPnP networking includes addressing, discovery, description, control, eventing, and presentation. UPnP provides support for communication between control points and devices. The network media, the TCP/IP protocol suite and HTTP provide basic network connectivity and addressing needed. On top of these open, standard, Internet based protocols, UPnP defines a set of HTTP servers to handle discovery, description, control, events and presentation.

Each device includes a DHCP client that searches for a DHCP server when the device is first connected to the network. If a DHCP server is available, the device uses the IP address assigned to it. If no DHCP server is available, the device uses Auto IP to get an address.

Once devices are attached to the network and addressed appropriately, discovery can take place. Discovery is handled by the SSDP as discussed earlier. When a device is added to the network, SSDP enables the device to advertise its services to control points on the network. When a control point is added to the network, SSDP enables the control point to search for devices on the network. The fundamental exchange in both cases is a discovery message containing a few, essential specifics about the device or one of its services, for example its type, identifier, and a pointer to its XML device description document.

The next step in UPnP networking is description. After a control point discovers a device, the control point still knows very little about the device. For the control point to learn more about the device and its capabilities, or to interact with the device, the control point must retrieve the device's description from the URL provided by the device in the discovery message.

Devices can include other logical devices and services. The UPnP description for a device is preferably expressed in XML and includes vendor-specific, manufacturer information including the model name and number, serial number, manufacturer name, URLs to vendor-specific Web sites, and so forth. The description also includes a list of any embedded devices or services, as well as URLs for control, eventing, and presentation.

After the control point has retrieved a description of the device, the control point has the essentials for device control. To learn more about the service, the control point must retrieve a detailed UPnP description for each service. The description for a service is also preferably expressed in XML and includes a list of the commands, or actions, the service responds to, and parameters or arguments, for each action. The description for a service also includes a list of variables. These variables model the state of the service at run time, and are described in terms of their data type, range, and event characteristics.

To control a device, the control point sends an action request to a device's service. To do this, the control point sends a suitable control message to the control URL for the service that is provided in the device description. Control messages are expressed in XML using SOAP. In response to the control message, the service returns action specific values or fault codes.

A UPnP description for a service includes a list of actions the service responds to and a list of variables that-model the state of the service at run time. The service publishes updates when these variables change, and a control point can subscribe to receive this information. The service publishes updates by sending event messages. Event messages include the names of one of more state variables and the current value of those variables. These messages are expressed in XML and formatted using GENA.

A special initial event message is sent when a control point first subscribes. This event message contains the names and values for all evented variables and allows the subscriber to initialize its model of the state of the service.

If a device has a URL for presentation, then the control point can retrieve a page from this URL, load the page into a browser, and depending on the capabilities of the page, allow a user to control the device and/or view device status. The degree to which each of these can be accomplished depends on the specific capabilities of the presentation page and device.

If applications are to be built on the services provided by the UPnP implementation, then an Application Programming Interface (API) is necessarily tailored to the platform the device is implemented on. APIs should enable all facets of UPnP including discovery, description, control, eventing and presentation.

### SUMMARY OF THE INVENTION

A device discovery application programming interface (API) provides an interface to discover the presence of network devices. The device discovery API of the present invention preferably resides within a control device, where the control device can also be a network device. Each network device preferably uses IP-based protocols for sending and receiving communications related to the discovery process. The interface is used as part of an application or as a standalone application. The device discovery API of the present invention provides an interface for an application to produce and maintain a list of network devices discovered on a network. The device discovery API enables the control point to search for a particular network device on the network and to search for particular information associated with the network device. The device discovery API also provides a framework for defining and implementing a device discovery protocol. The device discovery protocol is preferably IP-based. The device discovery API of the present invention is extensible, such that the framework for defining and implementing the device discovery protocol can also provide common functionality across multiple protocols.

In one aspect of the present invention, a control device coupled to a network of devices comprises one or more applications, a network layer coupled to interface with one or more network devices, and an interface layer coupled to communicate with the applications and the network layer to discover the presence of appropriate network devices. The network is preferably an Internet Protocol (IP) based network. The interface layer is an application programming interface (API) and is protocol independent. The network layer preferably includes a Universal Plug and Play protocol stack, and one or more network devices are Universal Plug and Play enabled devices.

In another aspect of the present invention, a method of providing an interface to applications resident within a control device coupled to a network of devices comprises sending and receiving messages to and from the applications through an interface layer to discover the presence of network devices, and generating and receiving communications at the interface layer to complete the discovery of the network devices. Communications generated at the interface layer are sent to a network layer within the control device and communications received at the interface layer are received from the network layer. The network layer preferably includes a Universal Plug and Play protocol stack and one or more of the network devices are Universal Plug and Play enabled devices. Communications received at the interface layer from the network layer include a notification from a network device that advertises the presence of the network device. The notification includes services offered by the network device and embedded devices available within the network device. Communications generated at the interface layer and sent to the network layer include an acknowledgment request for any network device that matches a specified search criteria. Communications received at the interface layer from the network layer include an acknowledgment from a network device that matches the specified search criteria. The acknowledgment includes a pointer to a location of a device description corresponding to the network device. The method further comprises compiling a list of the discovered network devices.

### BRIEF DESCRIPTION OF THE DRAWINGS

FIG. 1 illustrates a conventional protocol stack used to implement the Universal Plug and Play standard.

FIG. 2 illustrates an exemplary network of devices.

FIG. 3 illustrates a block diagram of an exemplary hardware system resident in each system implementing the device discovery API of the present invention.

FIG. 4 illustrates a discovery protocol.

FIG. 5 illustrates a protocol according to the present invention.

### DETAILED DESCRIPTION OF THE EMBODIMENTS

Embodiments of the present invention include a device discovery application programming interface (API) that provides an interface to discover the presence of network devices. The device discovery API preferably resides within a control device, where the control device can also be a network device. Each network device preferably uses IP-based protocols for sending and receiving communications related to the discovery process. The device discovery API of the present invention is designed to provide a simple and thin interface that can be used across many different platforms. The interface is preferably used as part of a web browser-based application. Alternatively, the interface is used as part of other applications or as a standalone application. The device discovery API provides an interface for an application to produce and maintain a list of network devices discovered on a network. Preferably, the discovered network devices are SSDP-enabled devices. The device discovery. API enables the control point to search for a particular network device on the network and to search for particular information associated with the network device. The device discovery API also provides a framework for defining and implementing a device discovery protocol. The device discovery protocol is preferably IP-based. The device discovery API is extensible, such that the framework for defining and implementing the device discovery protocol can also provide common functionality across multiple protocols.

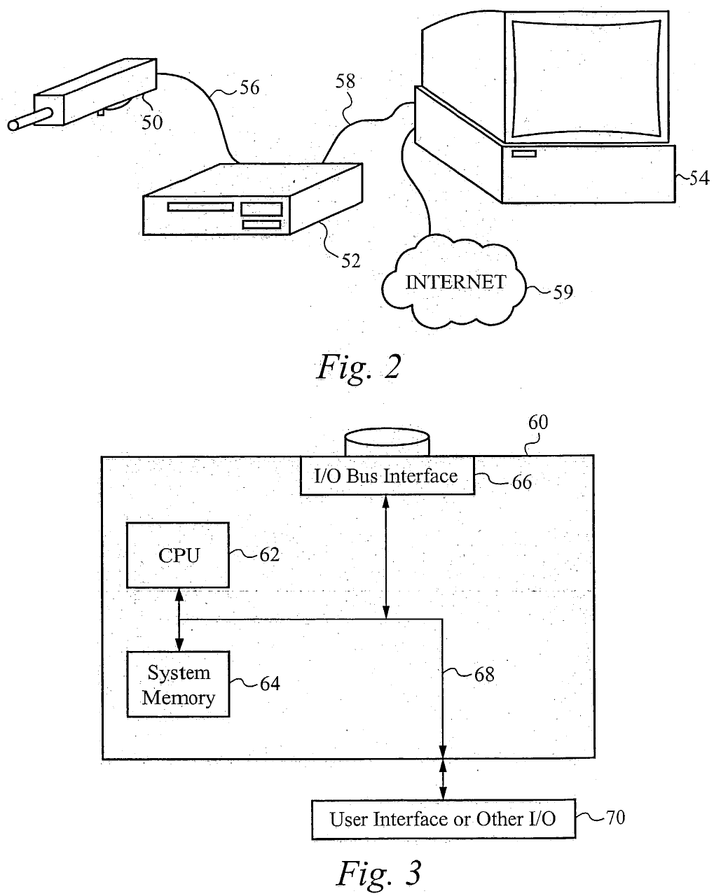

FIG. 2 illustrates an exemplary network of devices including a video camera 50, a video cassette recorder 52 and a computer 54 connected together by the input/output (I/O) busses 56 and 58. The I/O bus 56 couples the video camera 50 to the video cassette recorder 52, allowing the video camera 50 to send data to the video cassette recorder 52 for recording. The I/O bus 58 couples the video cassette recorder 52 to the computer 54, allowing the video cassette recorder 52 to send data to the computer 54 for display. At least one of the devices on the network is preferably coupled to the Internet to access device description information. Preferably, the computer 54 is coupled to the Internet 59. Alternatively, the computer 54 is coupled to any network that includes device description information.

In the preferred embodiment of the present invention, each of the subsystems, including the video camera 50, the video cassette recorder 52 and the computer 54 are Universal Plug and Play (UPnP) enabled. Within the exemplary network of devices of FIG. 2, the computer 54 is a control device. As such, the computer 54 includes an interface layer implementing the device discovery API according to the present invention for discovering the presence of network devices, which in the exemplary network of devices of FIG. 2 includes the video camera 50 and the video cassette recorder 52. The computer 54 also includes an API for providing control, query, and event communications between the computer 54, the video camera 50, and the video cassette recorder 52. This API is preferably a network device API as described in the co-pending U.S. patent application Ser. No. ______ filed on ______ and entitled “Network Device Application Interface” which is also hereby incorporated by reference. It should be understood by those skilled in the art that any other API can be used that provides an interface for control, query, and event communications between a control device and a network device. It is also understood that an interface layer implementing the device discovery API of the present invention and the network device API can also be implemented within any one or all connected subsystems, including the video camera 50, the video cassette recorder 52 or the computer 54, which is capable of discovering a network device and using the network device API to control the discovered network device.

A block diagram of an exemplary hardware system resident in each system implementing the interface layer of the present invention is illustrated in FIG. 3. In the hardware system illustrated in FIG. 3, a printed circuit board 60 is coupled to a user interface 70. The printed circuit board 60 includes a central processing unit (CPU) 62 coupled to system memory 64 and to an I/O bus interface 66 by a system bus 68. The user interface 70 is also coupled to the system bus 68. The user interface 70 is subsystem specific, but can include a keyboard, display or other I/O devices for communicating with a user of the subsystem. It should be apparent to those skilled in the art that there may be some devices implementing the interface layer of the present invention which do not include the user interface 70, such as a hard disk drive or similar device.

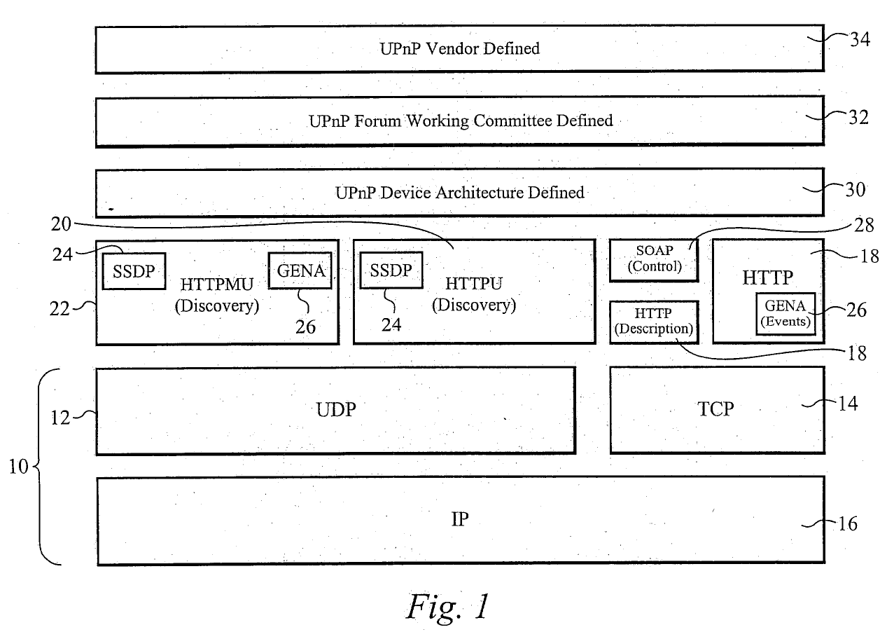

Each subsystem intending to implement the interface layer of the present invention will preferably include a hardware system such as the system illustrated in FIG. 3. As applied to the network of devices illustrated in FIG. 2 in which the computer 54 is a control device, the computer 54 includes the hardware system of FIG. 3. The CPU 62 within the computer 54 is used to execute the appropriate program instructions. The interface layer of the present invention will then provide a simplified interface between applications resident within the computer 54 and a network layer, such as the UPnP protocol stack illustrated in FIG. 1.

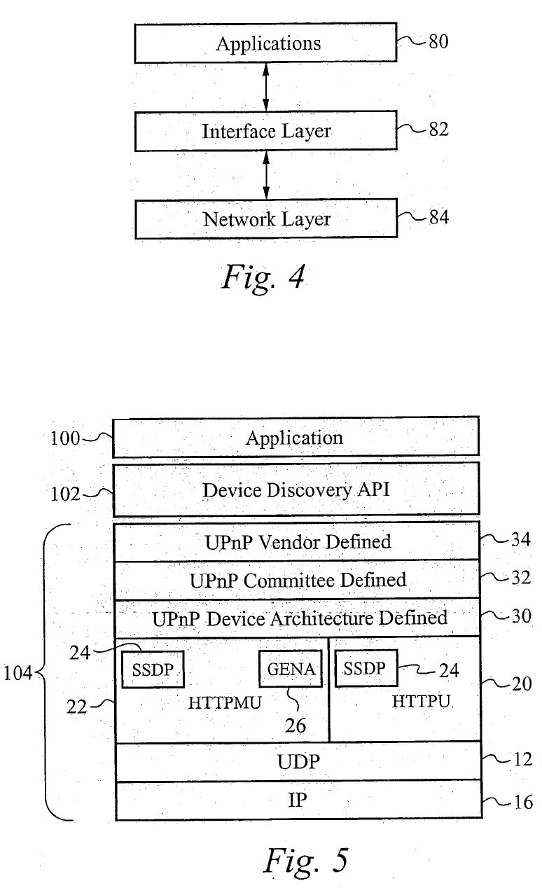

A protocol according to the present invention is illustrated in FIG. 4. An interface layer 82 is coupled to one or more applications 80 to provide discovery communications between the applications 80 included within the computer 54 and one or both of the video camera 50 and the video cassette recorder 52. The interface layer 82 is also coupled to communicate with a network layer 84 for generating necessary discovery communications with the video camera 50 and/or the video cassette recorder 52. The network layer 84 represents a supported protocol stack, such as the portion of the UPnP protocol stack illustrated in FIG. 1 used in the discovery process. The applications 80, the interface layer 82 and the network layer 84 are preferably resident within the control device, such as the computer 54. The interface layer 82 communicates with the applications 80 and the network layer 84 as necessary to provide discovery commands to and from the applications 80.

The interface layer acts as an abstraction layer such that an application can provide discovery communications to and receive discovery communications from a network device without knowing the specific type and associated protocols of the network device. The interface layer 82 preferably implements the device discovery API of the present invention.

The device discovery API defines basic functionality to discover the presence of a network device. The functionality includes sending search requests to the network device and receiving responses back, receiving advertisement-type messages from network devices announcing their presence on the network, storing and retrieving information about discovered network devices as a device list, receiving a device list request from an application, providing the device list to the application, and updating the device list.

The device discovery API also includes an input-output class that provides a system and browser independent interface for input-output functions, such as sending a message string out on a designated port, creating and/or deleting a port, and receiving a message string.

In one embodiment of the present invention, the device discovery API is used as an interface layer between applications and UPnP enabled devices. Communications to and from the UPnP enabled devices include the use of a UPnP protocol stack, such as the UPnP protocol stack illustrated in FIG. 1. The discovery process associated with UPnP includes two processes, advertisement and search. When a UPnP enabled device is added to a network, the UPnP discovery protocol allows that device to advertise its services to control points on the network. When the device is added to the network, it multicasts discovery messages advertising its embedded devices and services. Any interested control point can listen to the standard multicast address for notifications that new services are available.

The second discovery process associated with UPnP is the search process. A control point searches for network devices by multicasting an SSDP discovery message, also known as a search request. The search request can target any and/or all network devices that meet a particular search criteria. Examples of such search criteria include device type and services provided. All network devices must listen to the standard multicast address for these messages and must respond if any of their embedded devices or services match the search criteria in the discovery message. In general, the control point can search the network for all devices and their related services.

FIG. 5 illustrates an exemplary protocol including a UPnP protocol and the device discovery API of the present invention. A device discovery API 102 is coupled to an application 100 and a protocol stack 104. The protocol stack 104 is a portion of the UPnP protocol stack illustrated in FIG. 1 used during the discovery process. As such, the protocol stack 104 acts as a network layer. The device discovery API 102 acts as an abstraction layer between the application 100 and the protocol stack 104.

A network device, upon being added to the network, sends a GENA advertisement announcing its embedded devices and services. The GENA advertisement is sent in SSDP over HTTPMU. A control point sends search requests by multicasting a discovery message. These search request messages include vendor-specific information, such as device or service types and identifiers. The device or service types defined by a UPnP working committee for these types of devices are added to the search request message. This information is encapsulated in a SSDP request sent using HTTPMU. Responses to these search requests are sent using unicast UDP with SSDP headers using HTTPU. Responses to search requests include similar information as to advertisement-type discovery messages. Examples of such information include network device IP address, source port, and a device description URL.

The device discovery API of the present invention receives advertisement-type discovery messages from the network devices through the network layer, sends search requests to the network devices via the network layer, and receives responses to the search request from the network devices through the network layer. As described above, messages received from the network devices include device specific information such as IP address, source port, and a device description URL. An advertisement-type discovery message can also include a time stamp indicating a time for which the advertisement remains valid. Before this time expires the network device must re-send its advertisement. Otherwise, control points can assume the device is no longer available. When the network device goes offline, the device preferably sends a message to explicitly tell the network that it is going away.

Using the advertisement-type discovery messages and the search request responses from the network devices, the device discovery API of the present invention maintains one or more device lists. Each device list includes those network devices that match a defined criteria. Preferably, there is at least one device list that includes a list of all devices on the network. A device list can also be updated by the device discovery API. Updating can be performed at defined time intervals or whenever specific actions take place. Examples of such actions include performing a new search, receiving an advertisement-type discovery message from a device newly added to the network, expiration of a previously received time stamp, and receiving a going offline message.

In summary, the device discovery API of the present invention is an abstraction layer for an application within a control device. The device discovery API is resident within the control device and is used by the control device to send discovery communications to and receive discovery communications from one or more network devices. In the case where the network device is a UPnP enabled device, the device discovery API is the abstraction layer above the UPnP protocol used for the discovery process.

Although the device discovery API of the present intention is preferably used as an abstraction layer between an application and a UPnP protocol, it is understood that the device discovery API can also be used as an abstraction layer on-top of other network and device protocols.

The present invention has been described in terms of specific embodiments incorporating details to facilitate the understanding of the principles of construction and operation of the invention. Such references, herein, to specific embodiments and details thereof are not intended to limit the scope of the claims appended hereto. It will be apparent to those skilled in the art that modifications can be made in the embodiments chosen for illustration without departing from the spirit and scope of the invention. Specifically, it will be apparent to one of ordinary skill that while the preferred embodiment of the present invention is used with Universal Plug and Play enabled devices, the present invention can also be implemented on any other appropriate network device, or with any other appropriate protocols.

What is claimed is:

1. A control device coupled to a network of devices, the control device comprising:
a. one or more applications;
b. a network layer coupled to interface with one or more network devices; and
c. an interface layer coupled to communicate with the applications and the network layer to discover the presence of appropriate network devices.

2. The control device of claim 1 wherein the network is an Internet Protocol (IP) based network.

3. The control device of claim 1 wherein the interface layer is an application programming interface (API).

4. The control device of claim 1 wherein the interface layer is protocol independent.

5. The control device of claim 1 wherein the network layer includes a Universal Plug and Play protocol stack.

6. The control device of claim 5 wherein one or more network devices are Universal Plug and Play enabled devices.

7. A network comprising:
a. one or more network devices; and
b. a control device comprising:
i. one or more applications;
ii. a network layer coupled to interface with the one or more network devices; and
iii. an interface layer coupled to communicate with the applications and the network layer to discover the presence of appropriate network devices.

8. The network of claim 7 wherein the network is an Internet Protocol (IP) based network.

9. The network of claim 7 wherein the interface layer is an application programming interface (API).

10. The network of claim 7 wherein the interface layer is protocol independent.

11. The network of claim 7 wherein the network layer includes a Universal Plug and Play protocol stack.

12. The network of claim 11 wherein one or more network devices are Universal Plug and Play enabled devices.

13. A method of providing an interface to applications resident within a control device coupled to a network of devices, the method comprising:
a. sending and receiving messages to and from the applications through an interface layer to discover the presence of network devices; and
b. generating and receiving communications at the interface layer to complete the discovery of the network devices.

14. The method of claim 13 wherein communications generated at the interface layer are sent to a network layer within the control device and communications received at the interface layer are received from the network layer.

15. The method of claim 14 wherein the network layer includes a Universal Plug and Play protocol stack and one or more of the network devices are Universal Plug and Play enabled devices.

16. The method of claim 14 wherein communications received at the interface layer from the network layer include a notification from a network device that advertises the presence of the network device.

17. The method of claim 16 wherein the notification includes services offered by the network device.

18. The method of claim 16 wherein the notification includes embedded devices available within the network device.

19. The method of claim 14 wherein communications generated at the interface layer and sent to the network layer include an acknowledgment request for any network device that matches a specified search criteria.

20. The method of claim 19 wherein communications received at the interface layer from the network layer include an acknowledgment from a network device that matches the specified search criteria.

21. The method of claim 20 wherein the acknowledgment includes a pointer to a location of a device description corresponding to the network device.

22. The method of claim 13 further comprising compiling a list of the discovered network devices.
